(19) United States
(12) Patent Application Publication
(10) Pub. No.: US 2002/0003207 A1
(43) Pub. Date: Jan. 10, 2002

(54) Drive mechanism of optical scanner

(76) Inventor: Po-Hua Fang, Taipei (TW)

Correspondence Address: Raymond Sun, 12420 Woodhall Way, Tustin, CA, 92782, US

(21) Appl. No.: 09/746,572

(22) Filed: Dec. 22, 2000

(30) Foreign Application Priority Data
Jul. 4, 2000 (TW) 89211694

(51) Int. Cl. H01J 3/14

(52) U.S. Cl. 250/234

(57) ABSTRACT

A drive mechanism of optical scanner, includes an image pick-up device, a delivery device, a first motor and a second motor, the said image pick-up device can move back and forth in the scan path provided by optical scanner so as to perform image scan. The said delivery device consists of a actuating wheel, a passive wheel and a circular conveyor belt; the circular conveyor belt is harnessed on two rotating wheels and is connected to image pick-up device. The above-mentioned two motors provide rotational power of different rotational speed (torque) to propel the delivery device and rotate, so the image pick-up device is led into the scan path and scans back and forth. Then the scope of scan speed is enlarged to fit in with the required scan speed of the scanner under various resolutions.

### FIELD OF THE INVENTION

This invention relates to the drive mechanism of optical scanner. More particularly, two motors are used for providing the output (torque) of different rotation speed respectively, so the scope of scan speed is enlarged to fit in with the required scan speed of the scanner under various resolutions.

### BACKGROUND OF THE INVENTION

Scanner is a common peripheral equipment of computer, by means of internal image pick-up device to pick up document image and transfer the pick-up image into digital signal as input of computer and then perform image processing of the document.

FIG. 1A is a diagram showing optical scanner of prior art. The optical scanner of prior art comprises a housing 12 with upper opening 11, transparent manuscript surface 13 that could carry weight of document and an image pick-up device 14 with image pick-up function. The said transparent manuscript surface 13 is combined with upper opening 11 of the housing 11. The said image pick-up device 14 is set within the housing and is promoted to scan image by drive mechanism (not shown) provided by optical scanner 1, wherein image pick-up device 14 may be optical path device of Charged Couple Device (CCD) or Contact Image Sensor (CIS).

FIG. 1B is a diagram showing optical scanner's drive mechanism of conventional art. The drive mechanism 2 is mounted under the transparent manuscript surface, and promotes image pick-up device 14 to scan, comprising a scan path, a delivery device 22, a set of decelerated gears and a motor 24.

The scanning path 21 consists of a slip bar 211 and a sliding rail 212, the above slip and sliding rail parallel each other, and the image pick-up device 14 provides with a guide hole 141 and rotating wheel 142, and they cooperate with slip bar 211 and sliding rail 212 so as to scan back and forth in the scan path 21.

The delivery device 22 comprises a actuating gear 221, a passive gear 222 and a annular gear belt 223, wherein actuating gear 221 and passive gear are mounted in the two ends of the housing 12 respectively, the annular gear belt 223 is set on two gears 221, 222 respectively and parallel with scan path 21, furthermore the annular gear belt 223 combines with the image pick-up device 14.

The reduction gear set 23 is combined with motor 24 and actuating gear 221 respectively, its primary function is to provide appropriate reduction ratio so that rotational speed (torque) of motor 24 is reduced to appropriate extent and then communicate motive power to actuating gear 221.

Thus the scanning mode of drive mechanism is to promote the rotation of delivery device 22 by way of output power of motor 24 so that the annular gear belt 223 drives image pick-up device 14 to move back and forth in the scan path 21, and then scan document over the transparent manuscript surface.

However there are many design problems in the optical scanner 1 of the prior art. Since current consumers not only demand to increase the resolution of the optical scanner 1, also demand scanning speed as fast as possible simultaneously, but if the resolution of optical scanner is increased, speed of image processing becomes slow, then by adjusting reduction ratio of a reduction gear set or adopting higher rotational speed motor so as to increase scanning speed of optical scanner 1.

However whether DC motor or stepping motor, there both have definite specification and rotational speed (torque) range limit while left the factory, but all of the general companies purchase motor that has definite specification. Hence it is achieved by changing reduction ratio of reduction gear set, but if the wider the demanded resolution range of optical scanner, the larger the relative range of scanning speed; thus if adjust only reduction ratio change of reduction gear set that can not cover the needs of higher and lower scanning speed simultaneously, so if the motor which has two and more specifications is used and two scopes of rotational speed (torque) are provided in the same drive system simultaneously, the scanning speed scope of scanner is widened so as to match with scanning speed design of scanner under various resolutions.

### SUMMARY OF THE INVENTION

The main object of this invention is to provide a drive mechanism of optical scanner. The drive mechanism is provided wider scope of scanning speed for scanner and matched with scanning speed design of scanner that has various resolutions.

The drive mechanism of optical scanner according to the present invention comprises an image pick-up device, a delivery device, a first motor and a second motor and a controller, the said image pick-up device can move back and forth in the scan path provided by optical scanner so as to perform image scan. The said delivery device consists of a actuating wheel, a passive wheel and a annular conveyor belt; the above-mentioned two rotating wheels are set in the two ends of scan path, the circular conveyor belt is harnessed on two rotating wheels, wherein the circular conveyor belt is parallel with scan path and connects to image pick-up device, furthermore a set of decelerated gear is set in the axis of actuating gear and a appropriate reduction ratio is provided.

The first motor provides rotational power of the first rotational speed and its upper output shaft can drive reduction gear set to promote rotation of delivery device, while the second motor provides rotational power of the second rotational speed and its upper output shaft can drive reduction gear set to promote rotation of delivery device, the controller is connected to the two motors in the electrical connection way so that the drive mechanism is drove by one of the two motors at the same time and the other motor is controlled in the idle running.

Because the rotational speed of the first motor is different from rotational speed of the second motor and both the scopes of rotational speed (torque) provided by the above-mentioned two motors are the output scopes of drive mechanism's rotational speed. Hence the scan speed scope of scanner could be widened in order to fit in with the required scan speed design of the scanner under various resolutions.

These and other features and advantages of the present invention will be better understood by reference to the following detailed description when considered in connection with the accompanying drawings wherein:

### BRIEF DESCRIPTION OF THE DRAWINGS

FIG. 1A is an optical scanner diagram of prior art.

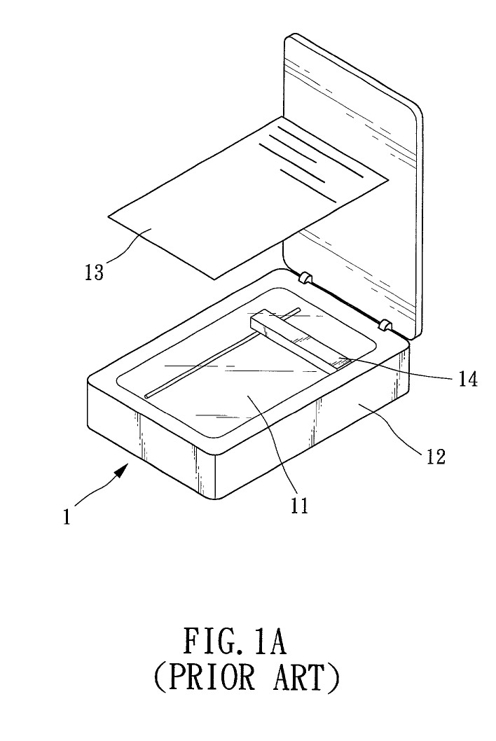

FIG. 1B is a drive mechanism diagram of optical scanner according to the prior art.

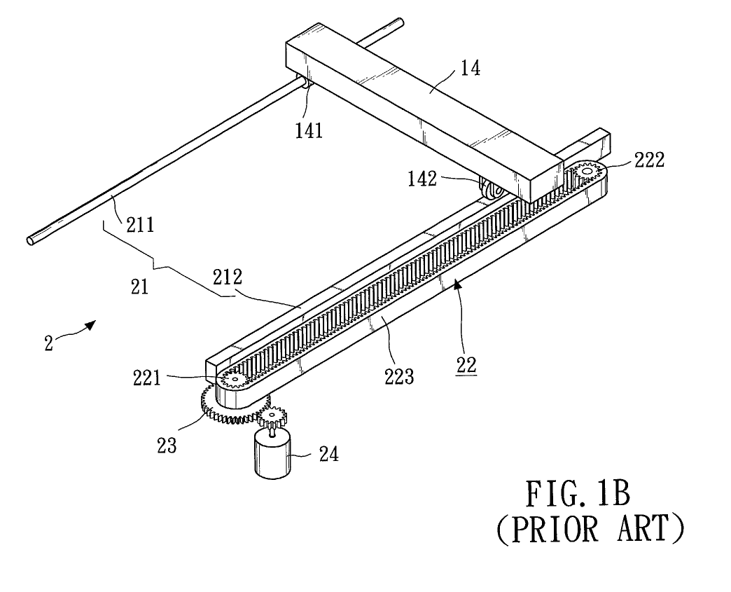

FIG. 2 diagrammatically represents a first embodiment of the drive mechanism according to optical scanner of the present invention.

FIG. 3 diagrammatically represents a second embodiment of the drive mechanism according to optical scanner of the present invention.

FIG. 4 diagrammatically represents a third embodiment of the drive mechanism according to optical scanner of the present invention.

### DETAILED DESCRIPTION OF THE PREFERRED EMBODIMENT

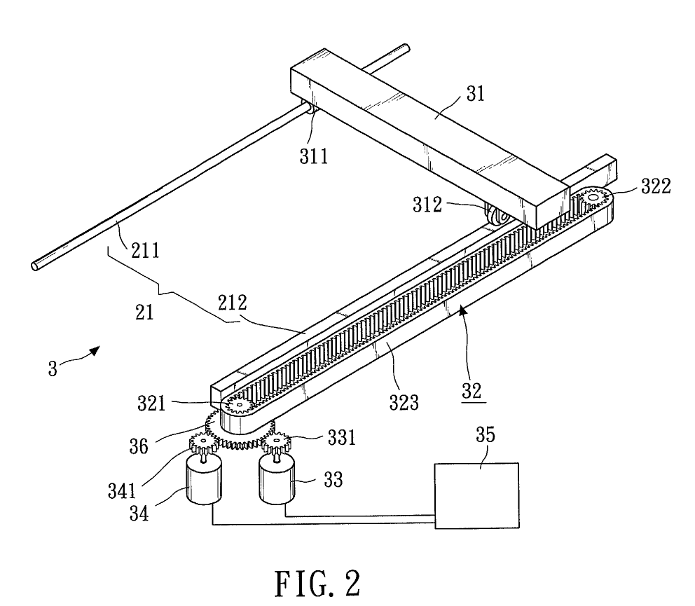

Refer to FIG. 2, diagrammatically represents a first embodiment of the drive mechanism according to optical scanner of the present invention, the drive mechanism comprises an image pick-up device 31, delivery device 32, a first motor 33, a second motor 34 and a controller 35.

The image pick-up device 31 may be an optical path device with a Charged Couple Device (CCD) or a Contact Image Sensor (CIS), it has a guide hole 311 and a roller 312, the scan path 21 provided by optical scanner 1 consists of two guide bars 211 that parallel each other and guide rail 212, the image pick-up device matches with guide bars 211 and guide rail respectively by means of guide hole 311 and roller 312 so that it can move back and forth in the scan path 21 to scan the document.

The delivery device 32 consists of actuating wheel 321, passive wheel 322 and a annular conveyor belt 323; the above-mentioned two rotating wheels 321,322 may be two fixed pulleys or two gears, and annular conveyor belt 323 may be a annular rope sheave (pulley) or annular gear are set in the two ends of scan path 21, and the annular conveyor belt is harnessed on two rotating wheels 321,322, wherein the annular conveyor belt is parallel with scan path 21 and connects to image pick-up device 31, furthermore a reduction gear set is set in the axis of actuating gear and a appropriate reduction ratio is provided.

The first motor 33 may be a DC motor or stepping motor, on its output shaft the motor 33 is combined with a gear 331 that engages with a set of reduction gear 36. The first motor 33 provides rotational power of the first rotational speed and the power can drive reduction gear set 36 to promote rotation of delivery device 32 so that the image pick-up device 31 moves back and forth in the scan path 21 in order to scan the document.

The second motor 34 may be a DC motor or stepping motor, on its output shaft the motor 34 is combined with a gear 341 that engages with a set of reduction gear 36. The second motor 34 provides rotational power of the second rotational speed and the power can drive reduction gear set 36 to promote rotation of delivery device 32 so that the image pick-up device 31 moves back and forth in the scan path 21 in order to scan the document.

The controller 35 is connected to the first motor 33 and the second motor 34 respectively in the electrical connection way, the drive mechanism 3 is drove only by one of the two motors at the same time and the other motor is controlled in the idle running through control of the controller 35. Hence according to the invention, the scope of rotational speed (torque) provided by the first motor 33 or second motor 34 is served as the rotational speed (torque) scope of drive mechanism 3 and the rotational speed (torque) scope of drive mechanism 3 is further widened. Due to drive mechanism 3 outputs larger rotational speed (torque) scope according to the invention, thus how the resolution of optical scanner is designed in any case, a appropriate rotational speed (torque) could be found in the drive mechanism 3 to match with optical scanner 1, so the application scope of drive mechanism 3 of optical scanner 1 is widened relatively.

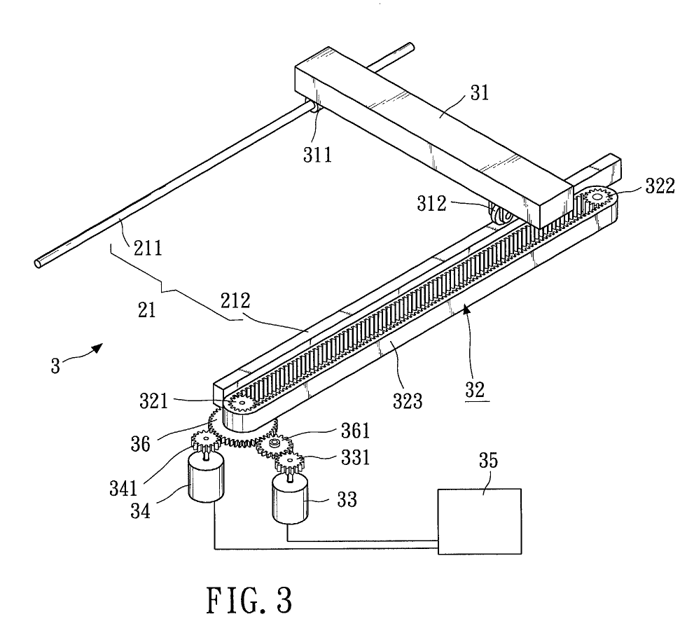

Refer to FIG. 3, a second embodiment of the drive mechanism according to optical scanner of the present invention. Most components within the embodiment are the same as the first embodiment and thus given unnecessary details no more, here only the differences are described. The greatest difference according to the embodiment is that rotational speed (torque) output of the first motor 33 equals to rotational speed (torque) output of the second motor 34, but different reduction ratio could be created by means of different size of gear combination so that enable two identical motors 33,34 to create different scope of rotational speed (torque). For example, the different diameter gears 331,341 are mounted on the output shaft of first and second motor 33,34, or a reduction gear set 361 is set between reduction gear ser 36 and the first motor, thus enable the two motors of identical rotational speed (torque) to create larger scope output of rotational speed (torque).

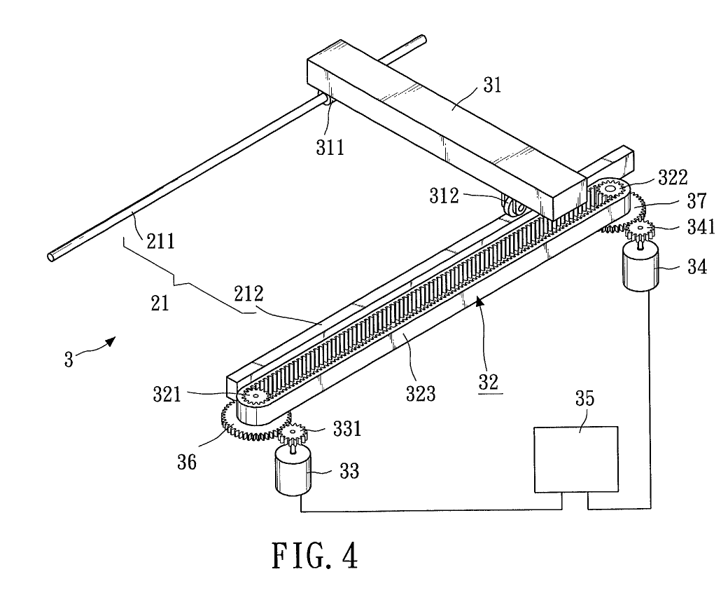

Refer to FIG. 4, a third embodiment of the drive mechanism according to optical scanner of the present invention. Besides a reduction gear set 36 is installed on the axis of the actuating wheel 221 according to the embodiment, a reduction gear set 37 is installed on the axis of the actuating wheel 222 simultaneously and enable the output shaft's gear 331 of first motor 33 to engage with the reduction gear set 36 of actuating wheel 321 while the output shaft's gear 341 of second motor 34 to engage with the reduction gear set 37 of actuating wheel 322. Controller 35 controls both the above-mentioned motors 33,34, now reduction ratios of reduction gear sets 36,37 which are installed on the actuating wheel 321 and passive wheel 322 respectively may be identical and motor of different rotational speed (torque) is used, or different reduction ratio of reduction gear sets 36,37 and motor of identical rotational speed (torque) is used.

It is worthy to mention that although the motor which is used by the above three embodiments may be a DC motor or stepping motor, but a encoder must be added if a DC motor is used so as to track the position of image pick-up device at any time in the scan path.

Of course, the drive mechanism of optical scanner according to the present invention has been described above by taking the case as better embodiment, but implementation scope of the present invention is not really limited to the scope of the embodiment described. All of the modifications, which are made by those whose familiar with the art without departing from the spirit of the invention, are belong to the scope of the present invention. Thus the protective scope of the invention is based on the following claims.

What is claimed is:

1. A drive mechanism for optical scanner, comprising:
an image pick-up device which can move back and forth in the scan path provided by the said optical scanner to scan image;
a delivery device consists of a actuating wheel, a passive wheel and a annular conveyor belt, the above-mentioned two wheels are set in the two ends of scan path, the said circular conveyor belt is harnessed on the two wheels and is connected to image pick-up device;
a first motor which provides rotational power of the first rotational speed and drives actuating wheel in order to promote image pick-up device that scans back and forth in the scan path, and
a second motor which provides rotational power of the second rotational speed and drives actuating wheel in order to promote image pick-up device that scans back and forth in the scan path;
wherein the delivery device is drove by one of the two motors at the same time and the other motor is controlled in the idle running.

2. A drive mechanism of optical scanner according to claim 1, wherein the image pick-up device is an optical path device with charge-coupled device.

3. A drive mechanism of optical scanner according to claim 1, wherein the image pick-up device is a contact image sensor.

4. A drive mechanism of optical scanner according to claim 1, wherein the image pick-up device provides scan path and they are guide bar and guide rail which parallel each other, image pick-up device has a guide hole and a roller and cooperate with guide bar and guide rail so as to scan back and forth in the scan path.

5. A drive mechanism of optical scanner according to claim 1, wherein the above two wheels of delivery device are two fixed pulleys, and the annular conveyor belt is an annular belt.

6. A drive mechanism of optical scanner according to claim 1, wherein the above two wheels of delivery device are two gears; the annular conveyor belt is an annular gear belt.

7. A drive mechanism of optical scanner according to claim 1, wherein the axes of delivery device's two wheels are connected to reduction gear set respectively and combined with the first, second motor respectively by means of the above-mentioned two reduction gear sets.

8. A drive mechanism of optical scanner according to claim 1, wherein a gear is established in the output ends of the above-mentioned two motors respectively, the above-mentioned motor drives actuating wheel to rotate by means of the said gear.

9. A drive mechanism of optical scanner according to claim 7, wherein a reduction gear set is used to connect between the first motor and reduction gear set.

10. A drive mechanism of optical scanner according to claim 1, wherein the drive mechanism further comprising a controller is connected to the above-mentioned two motors with electrical connection way so that one of the two motors is served as dynamical output at the same time and the other motor is controlled in the status of idle running.

11. A drive mechanism of optical scanner comprising:
an image pick-up device which can move back and forth in the scan path provided by the said optical scanner to scan image;
a delivery device consists of a actuating wheel, a passive wheel and a annular conveyor belt, the above-mentioned two wheels are set in the two ends of scan path, the said circular conveyor belt is harnessed on the two wheels and is connected to image pick-up device;
a first motor which provides rotational power of the first rotational speed and drives actuating wheel in order to promote image pick-up device that scans back and forth in the scan path, and
a second motor which provides rotational power of the second rotational speed and drives actuating wheel in order to promote image pick-up device that scans back and forth in the scan path;
wherein the delivery device is drove by one of the two motors at the same time and the other motor is controlled in the idle running.

12. A drive mechanism of optical scanner according to claim 11, wherein the image pick-up device is an optical path device with charge-coupled device.

13. A drive mechanism of optical scanner according to claim 11, wherein the image pick-up device is a contact image sensor.

14. A drive mechanism of optical scanner according to claim 11, wherein the image pick-up device provides scan path and they are guide bar and guide rail which parallel each other, image pick-up device has a guide hole and a roller and cooperate with guide bar and guide rail so as to scan back and forth in the scan path.

15. A drive mechanism of optical scanner according to claim 11, wherein the above two wheels of delivery device are two fixed pulleys, and the annular conveyor belt is an annular belt.

16. A drive mechanism of optical scanner according to claim 11, wherein the above two wheels of delivery device are two gears; the annular conveyor belt is an annular gear belt.

17. A drive mechanism of optical scanner according to claim 11, wherein the axes of delivery device's two wheels are connected to reduction gear set respectively and combined with the first, second motor respectively by means of the above-mentioned two reduction gear sets.

18. A drive mechanism of optical scanner according to claim 11, wherein a gear is established in the output ends of the above-mentioned two motors respectively, the above-mentioned motor drives actuating wheel and passive wheel to rotate by means of the said gear.

19. A drive mechanism of optical scanner according to claim 11, wherein the drive mechanism further comprising a controller is connected to the above-mentioned two motors with electrical connection way so that one of the two motors is served as dynamical output at the same time and the other motor is controlled in the status of idle running.
